(19) United States
(12) Patent Application Publication
(10) Pub. No.: US 2008/0127313 A1
(43) Pub. Date: May 29, 2008

(54) SYSTEM AND METHOD FOR PROVIDING HANDSET INSURANCE IN A WIRELESS ENVIRONMENT

(75) Inventors: James A. Payne, Woodstock, GA (US); Max G. Faulkner, Roswell, GA (US); Charles M. Link, Atlanta, GA (US)

Correspondence Address: AMIN, TUROCY & CALVIN, LLP, 1900 EAST NINTH STREET, 24TH FLOOR, NATIONAL CITY CENTER, CLEVELAND, OH, 44114, US

(73) Assignee: Cingular Wireless II, LLC, Atlanta, GA (US)

(21) Appl. No.: 11/564,379

(22) Filed: Nov. 29, 2006

(51) Int. Cl. H04L 9/32; G06Q 40/00

(52) U.S. Cl. 726/5; 705/4

(57) ABSTRACT

The claimed subject matter provides systems and/or methods that facilitate collecting data within a wireless communications network. A device can be connected to a wireless communications network. A retrieval component incorporated into the wireless communications network can automatically collect identification data associated with the device, the identification data specifies the type of device connected to the wireless communications network.

### TECHNICAL FIELD

The subject innovation relates to transferring data via a wireless communications network, and more specifically, to communicating device identification data to a network.

### BACKGROUND

The mobile telephone industry has been associated with tremendous growth over the last several years. For instance, in the recent past, mobile telephones were only available to those of highest economic status due to service costs and costs associated with mobile phones. Moreover, network coverage was not extensive enough to enable robust service. In particular, only areas associated with dense population were provided with extensive wireless network coverage. Still further, the mobile phones that could utilize the networks to communicate were quite bulky, causing portation of the phone over any significant distance to be difficult at best. In more detail, antennas associated with these phones could be over a foot in length, thus making it difficult to utilize the phones in automobiles or other congested areas.

In contrast, today's mobile devices (e.g., mobile phones, personal digital assistants (PDAs), any suitable user equipment for communciation, . . . ) can be utilized as full-service computing mechanisms. For example, many of the most recent and advanced mobile devices can be associated with word processing software, web browsing software, electronic mail software, accounting software, and various other types of software. Moreover, mobile devices can oftentimes be utilized as cameras, videocameras, audio recorders, and the like. Furthermore, network coverage has expanded to cover millions, if not billions, of users. Additionally, mobile devices have decreased in both size and cost. Specifically, modern mobile devices are often small enough to slip into an individual's pocket without discomforting the individual. Furthermore, many mobile network service providers offer phones and/or disparate devices at extremely low cost to customers who contract for service with such providers.

Mobile device service providers typically offer a wide range of service plans with an even broader range of mobile devices to activate/utilize therewith. In addition, consumers are typically enticed to particular mobile device service providers by mobile device rebates coupled to contracted service plans for a time period. This practice can enable consumers to purchase expensive and lavish devices at a fraction of the cost. The mobile device service providers further allow insurance to be purchased and/or added to a service plan to protect such investments, wherein the insurance allows a mobile device to be repaired and/or replaced upon being damaged, lost, and/or stolen. Yet, a frightening number of consumers take advantage of mobile device insurance by committing insurance fraud (e.g., insuring a more expensive device in comparison to the device actually used with the service plan, reporting stolen/lost devices when such devices are not lost/stolen, requesting insurance on an already damaged phone, etc.).

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The claimed subject matter described herein relates to systems and/or methods that facilitate automatically collecting device identification data within a wireless communication network. A retrieval component can automatically collect data (e.g., device identification data and also referred to as identification data) related to a device associated with a network. The retrieval component can periodically capture and/or collect such identification data in order to glean details related to the particular devices connected and/or utilizing the network (e.g., wireless communications network). In general, the identification data can be any suitable data that can specify a device on the network such as International Mobile Station Equipment Identity (IMEI) data, device serial number, device identification number, consumer device linkage data (e.g., consumer address, consumer social security number, consumer name, etc.), and/or any other suitable data that can identify a device. It is to be appreciated that the device can be, for instance, user equipment, a mobile device, a communication device, a mobile communication device, a gaming device, a portable media player, a cellular phone, a mobile phone, a portable device (e.g., laptop, handheld such as a personal digital assistant (PDA), portable music player, portable gaming device, . . . ), a desktop device, a home media center, a smartphone, any suitable device that can include identification data, any suitable device that can be employed on the network, etc.

In accordance with various aspects of the claimed subject matter, the retrieval component can utilize an insurance component that can facilitate providing insurance coverage for the device based at least in part upon the registered and/or collected identification data associated with the device. The insurance component can further calculate an insurance rate associated with the device identified by the identification data based upon a characteristic of the device (e.g., brand, make, model, frequency of repair, etc.). In accordance with another aspect of the subject innovation, the retrieval component can employ a dynamic insurance component that can generate a dynamic insurance rate based on a particular device identified by the identification data. In accordance with still another aspect of the subject innovation, the retrieval component can utilize a trend component that can provide various statistical analysis associated with the network based at least in part upon the device identification data captured. In particular, the trend component can create tables, graphs, charts, reports, documents, electronic files, etc. that can be employed in areas such as marketing, business, sales, and the like. In other aspects of the claimed subject matter, methods are provided that facilitate automatically registering a device with insurance via device identification data within a wireless communication network.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a block diagram of an example system that facilitates automatically collecting device identification data within a wireless communication network.

FIG. 2 illustrates a block diagram of an example system that facilitates collecting and storing device identification data within a wireless communication network.

FIG. 3 illustrates a block diagram of an example system that facilitates automatically registering a device with insurance via device identification data within a wireless communication network.

FIG. 4 illustrates a block diagram of an example system that facilitates utilizing device identification data collected within a wireless communication network.

FIG. 5 illustrates a block diagram of an example system that facilitates employing device identification data for trending analysis within a wireless communication network.

FIG. 6 illustrates a block diagram of an example system that facilitates automatically collecting device identification data within a wireless communication network.

FIG. 7 illustrates an example methodology that facilitates collecting and storing device identification data within a wireless communication network.

FIG. 8 illustrates an example methodology that facilitates automatically registering a device with insurance via device identification data within a wireless communication network.

FIG. 9 illustrates a block diagram of an example computing device such as a mobile device or a remote device described herein.

FIG. 10 illustrates an exemplary network architecture that can be employed in connection with various aspects associated with the claimed subject matter.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

As used in this application, the terms “component,” “system,” “equipment,” “network,” and the like are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips, . . . ), optical disks (e.g., compact disk (CD), digital versatile disk (DVD), . . . ), smart cards, and flash memory devices (e.g., card, stick, key drive, . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

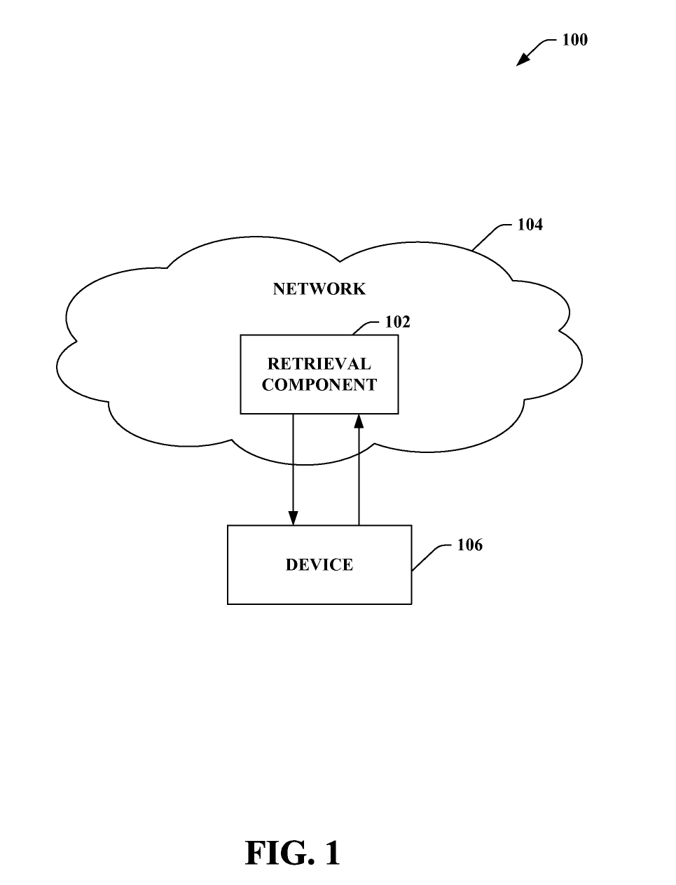

Referring initially to the drawings, FIG. 1 illustrates a system 100 that facilitates automatically collecting device identification data within a wireless communication network. The system 100 can include a retrieval component 102 incorporated into a network 104 that can automatically retrieve and/or collect data associated with a device 106, wherein such data can be identification data that uniquely specifies a particular device in accordance with the network 104. In other words, the retrieval component 102 can initiate the collection of device 106 identification data to allow tracking and/or storage of such information for implementation in the network 104, whereas conventional systems/methods required a consumer and/or user related to such device 106 to provide such data. In particular, the data can be identification data (e.g., also referred to as device identification data) such as, but not limited to, International Mobile Station Equipment Identity (IMEI) data, device serial number, device identification number, consumer device linkage data (e.g., consumer address, consumer social security number, consumer name, etc.), and/or any other suitable data that can identify a device. For example, upon the registering and/or detection of the device 106 on the network 104, the retrieval component 102 can automatically capture the device identification data. It is to be appreciated that the identification data associated with the device 106 can be utilized for a plurality of services provided by the network 104 such as, but not limited to, device insurance, trending analysis, marketing analysis, fraud prevention, etc. In another example, the retrieval component 102 can capture the identification data from the device based at least in part upon a time interval, wherein the time interval can be seconds, minutes, hours, days, weeks, months, years, and/or any suitable increment of time.

Moreover, the device can be, but is not limited to being, user equipment, a mobile device, a communication device, a mobile communication device, a gaming device, a portable media player, a cellular phone, a mobile phone, a portable device (e.g., laptop, handheld such as a personal digital assistant (PDA), portable music player, portable gaming device, . . . ), a desktop device, a home media center, a smartphone, any suitable device that can include identification data, any suitable device that can be employed on the network 104, etc. Thus, the identification data associated with any device on the network 104 can be collected by the retrieval component 102 in order to allow the network 104 to track such data respective to each device and corresponding user, client, consumer, and the like.

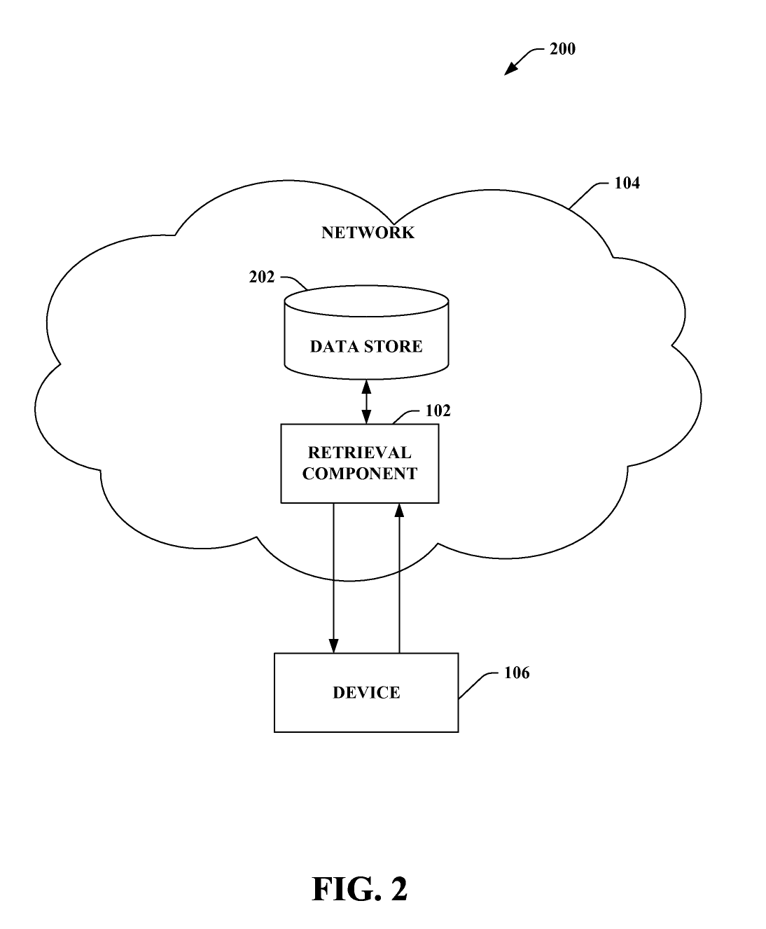

With reference to FIG. 2, illustrated is a system 200 that facilitates collecting and storing device identification data within a wireless communication network. The system 200 can include the network 104 with an incorporated retrieval component 102 that automatically can collect device identification data that is unique to the device 106. The retrieval component 102 can utilize a data store 202 that can store any suitable data associated with the system 200. In particular, the data store 202 can store a portion of device data, device identification data, IMEI data, device serial number data, device identification number, consumer device linkage data (e.g., consumer address, consumer social security number, consumer name, etc.), data collected from the device 106, account data associated with the device 106 (e.g., insurance package, insurance details, service package details, etc.), any other suitable data that can identify a device, configurations, settings, metadata associated with device identification data, trending data, device insurance data, analysis data, marketing data, fraud data, etc. The data store 202 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 202 of the subject systems and methods is intended to comprise, without being limited to, these and any other suitable types of memory. In addition, it is to be appreciated that the data store 202 can be a server, a database, a hard drive, and the like.

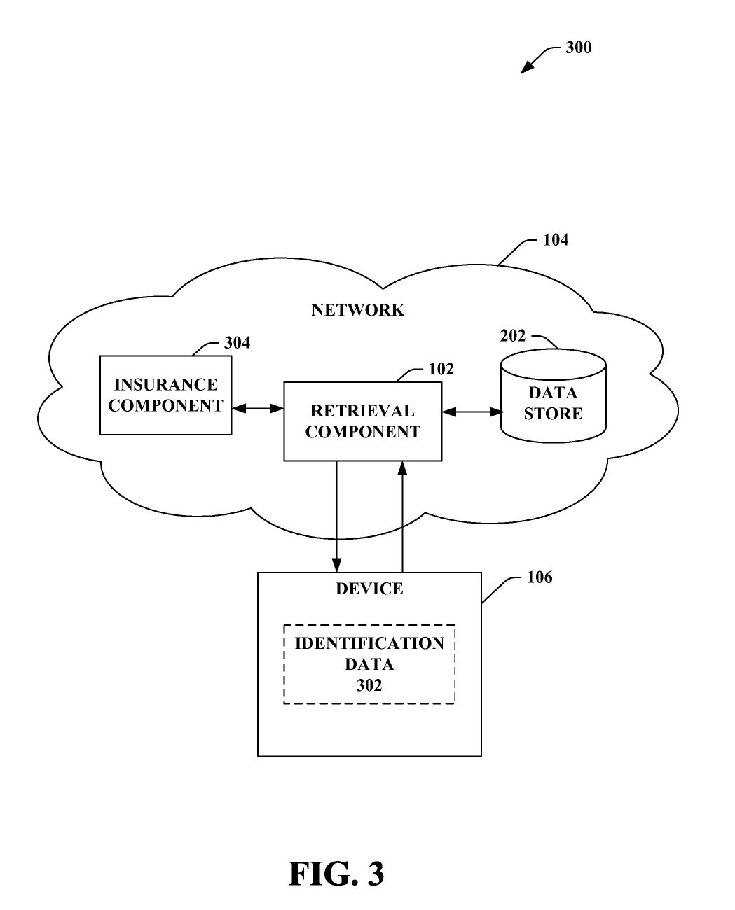

Turning to FIG. 3, illustrated is a system 300 that facilitates automatically registering a device with insurance via device identification data within a wireless communication network. The system 300 can include the retrieval component 102 that can automatically collect identification data 304 from the device 106 to utilize within the network 104. In particular, the retrieval component 102 can automatically contact the device 106 utilizing data communication (e.g., text message, multimedia message service (MMS), web browser, automated cellular call, and the like), wherein the identification data 302 can be collected/retrieved and stored in the data store 202. It is to be appreciated that the retrieval component 102 can collect and/or retrieve identification data 302 from a plurality of devices associated with the network 104, wherein each device includes specific identification data 302 associated therewith.

The retrieval component 102 can further utilize an insurance component 304 that can provide insurance coverage for the device 106 based at least in part upon the registered and/or collected identification data 302 associated with the device 106. In particular, the network 104 can ascertain details associated with the device 106 based upon the collected identification data 302 such as, but not limited to, brand, type, model, functional capability, specifications, details, and the like. Moreover, based upon such detail information associated with the device 106, the insurance component 304 can calculate and/or provide insurance coverage particular to the device 106. In addition, such insurance coverage can be specific to and/or correlate with the device 106 to ensure insurance integrity for the device 106 covered and the coverage provided (e.g., to assist in preventing fraud, etc.). In other words, the network 104 can know and/or track the device 106 insured and/or covered so as to allow the correct replacement/repairs to be made upon receiving an insurance claim.

In one example, the insurance component 304 can periodically capture the identification data (e.g., International Mobile Station Equipment Identity (IMEI) data, device serial number, device identification number, consumer device linkage data, consumer address, consumer social security number, consumer name, any suitable data that can identify a device, etc.) of the device 106. Such captured identification data 302 can be compared with the information stored on the data store 202 to ascertain which device a customer and/or user is currently using. The network 104 and/or carrier (e.g., service provider) can send updates to the customers and/or users alerting them when the device currently carrying is different from the device registered on their device insurance policy. By employing this, the carrier and/or network 104 can implement, for instance, dynamic insurance rates (e.g., discussed in more detail infra) for each device 106 and in turn each user(s) of such device 106.

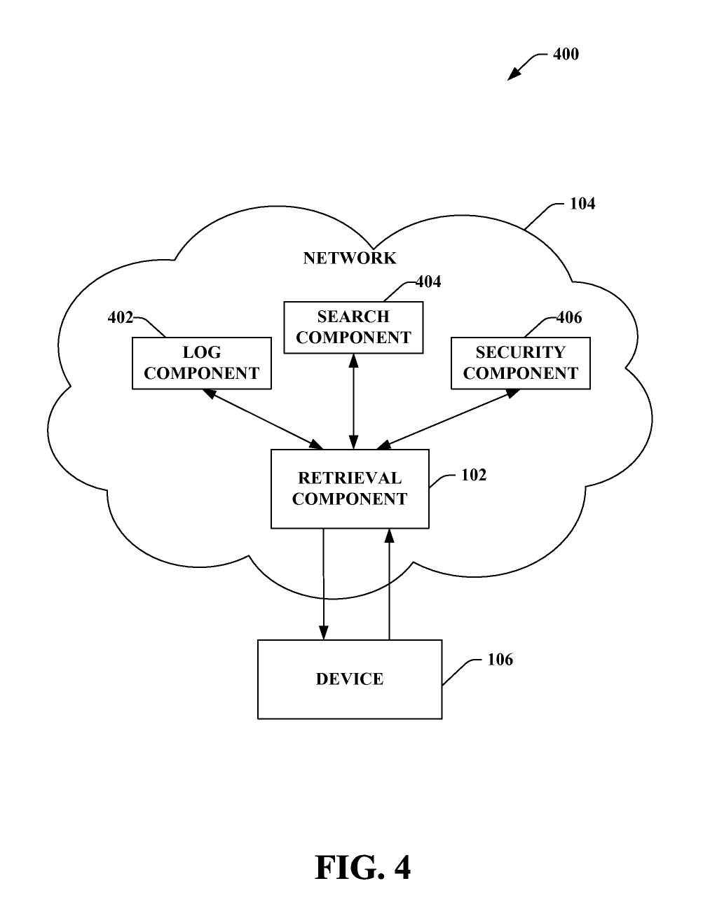

Referring now to FIG. 4, illustrated is a system 400 that facilitates utilizing device identification data collected within a wireless communication network. The retrieval component 102 can utilize a log component 402 that tracks device identification data associated with the device 106. It is to be appreciated that the log component 402 can be a stand-alone component, incorporated into the retrieval component 102, incorporated into the network 104, and/or any combination thereof. The log component 402 can log various information related to the device 106, the user(s) of such device 106, service packages associated with the device 106, changes associated with the device 106, and the like. Moreover, the log component 402 can store the logged entries in a data store (not shown).

The retrieval component 102 can further implement a search component 404 that facilitates querying any data associated with the system 400. The search component 404 allows a user and/or any component to query to system 400 in relation to devices, identification data, service package data, account data, user data, details associated with service plans, etc. For instance, a user can query the system 400 utilizing the search component 404 to locate a particular device 106 and corresponding account details. It is to be appreciated that a plurality of searches and/or queries can be implemented by the search component 404 and the above example is not to be limiting on the claimed subject matter. Moreover, it is to be appreciated that the search component 404 is depicted as a stand-alone component, but the search component 404 can be incorporated into the retrieval component 102, incorporated into the network 104, a stand-alone component, and/or any combination thereof.

The location component 104 can further utilize a security component 406 that provides security to the system 400 to ensure data integrity and/or access. In particular, the security component 406 can define security, authorization, and/or privileges in accordance with at least one of a pre-defined hierarchy, security level, username, password, access rights, data importance (e.g., more important data correlates with high security clearance), etc. For instance, a particular portion of device identification data can be a first security level with distinct security authorizations and/or privileges, while a disparate portion of device identification data can have a second security level with disparate security authorizations and/or privileges. Thus, the security component 406 can provide granular security in relation to devices, device identification data, account package data, service plan data, customer data, insurance package data, account history data, etc. It is to be appreciated that there can be various levels of security with numerous characteristics associated with each level and that the subject innovation is not limited to the above example. In other words, the security component 406 provides granular security and/or privileges to the system 400. It is to be appreciated that security component 406 can be a stand-alone component, incorporated into the retrieval component 102, incorporated into the network 104, and/or any combination thereof.

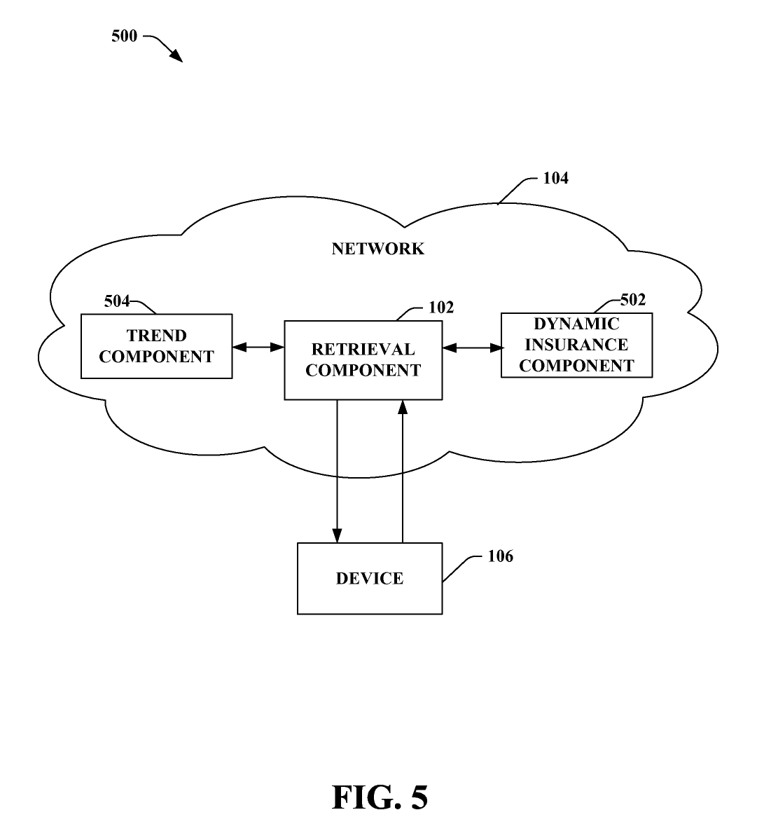

FIG. 5 illustrates a system 500 that facilitates employing device identification data for trending analysis within a wireless communication network. The system 500 can include the retrieval component 102 that can capture identification data associated with the device 106 such as, but not limited to, International Mobile Station Equipment Identity (IMEI) data, device serial number, device identification number, consumer device linkage data (e.g., consumer address, consumer social security number, consumer name, etc.), and/or any other suitable data that can identify a device. The capturing and/or collecting of the device identification data can allow the network 104 to track such data respective to each device and corresponding user, client, consumer, and the like.

The retrieval component 102 can utilize a dynamic insurance component 502 that can employ dynamic insurance rates respective to the device 106 and respective user(s). In general, the system 500 can ascertain the specific device 106 employed by a particular customer and/or user. Based on the identification data specifying which device is used, the dynamic insurance component 502 can vary the insurance rate associated therewith. For instance, if the customer/user is using a higher-end device than registered on an insurance policy, the carrier and/or network 104 can increase the insurance rate based on pre-negotiated pricing. In another example, a customer/user's insurance rate can be lowered when switching to a lower-end device. In addition, the dynamic insurance component 502 can utilize any suitable data associated with the device 106 identified by the respective identification data such as, but not limited to, age of the device (e.g., insurance can lower as device gets older), frequency of repair required to that device, length of contract with network/carrier/service provider, payment history, frequency of insurance claim, customer/user loyalty to insurance provider, device parts prices, labor prices, device repair cost, and/or any other suitable factor associated with the device 106 and/or the network 104.

The retrieval component 102 can further employ a trend component 504 that can provide various statistical analysis associated with the network 104 based at least in part upon the device identification data that correlates to the device 106. For instance, the trend component 504 can aggregate the various amount of device identification data in order to determine particular trends and/or tendencies associated with customers/users related to the network 104. In one example, the trend component 504 can create tables, graphs, charts, reports, documents, electronic files, etc. that can be employed in areas such as marketing, business, sales, and the like. With the retrieval component 102 collecting the device identification data, the trend component 504 can ascertain the specific devices utilized by users/customers associated with the network 104. Such information can assist in determining what customers/consumers/users like and/or dislike in relation to devices. For example, if a user buys a first device, the retrieval component 102 can collect respective device identification data. Yet, if the user dislikes the first device, the user can buy a second device with device identification data that can be collected by the retrieval component 102. Based on the collected data, the trend component 504 can then analyze the collected data associated with the user and make the determination that the first device was not successful for the particular user.

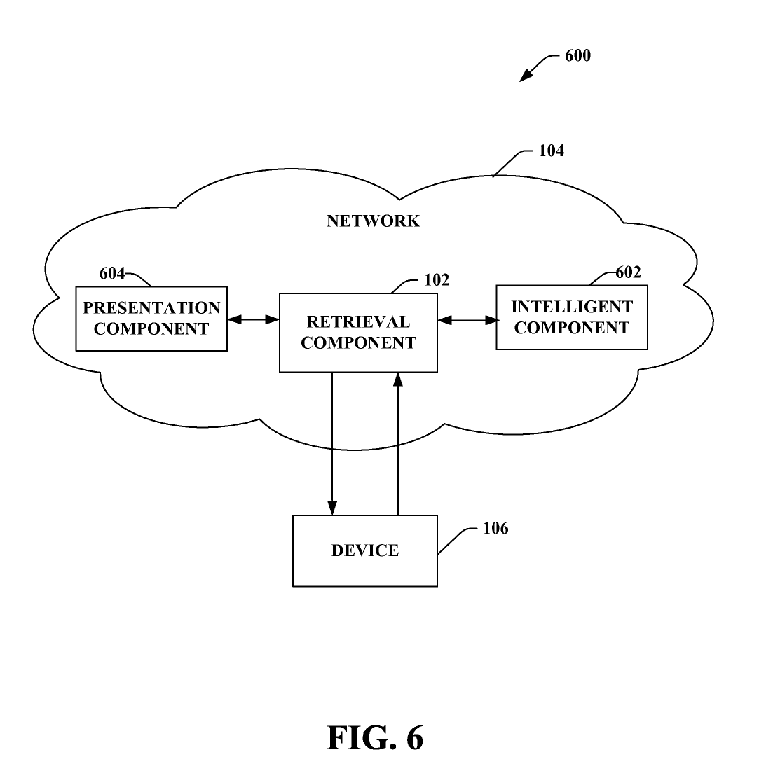

With reference to FIG. 6, illustrated is a system 600 that employs intelligence to facilitate collecting device identification data within a wireless communication network. The system 600 can include the retrieval component 102, the network 104, and the device 106 that can all be substantially similar to respective components, networks, and devices described in previous figures. The system 600 further includes an intelligent component 602. The intelligent component 602 can be utilized by the retrieval component 102 to facilitate automatically capturing device identification data for implementation within the network 104. For instance, the intelligent component 602 can infer device identification data, account preferences, service package preferences, insurance details, service plan details/preferences, trending data, marketing analysis, business data, etc.

It is to be understood that the intelligent component 602 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

A presentation component 604 can provide various types of user interfaces to facilitate interaction between a user and any component coupled to the retrieval component 102. As depicted, the presentation component 604 is a separate entity that can be utilized with the retrieval component 102. However, it is to be appreciated that the presentation component 604 and/or similar view components can be incorporated into the retrieval component 102 and/or a stand-alone unit. The presentation component 604 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled to the retrieval component 102.

The user can also interact with the regions to select and provide information via various devices such as a mouse, a roller ball, a keypad, a keyboard, a pen and/or voice activation, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can than provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

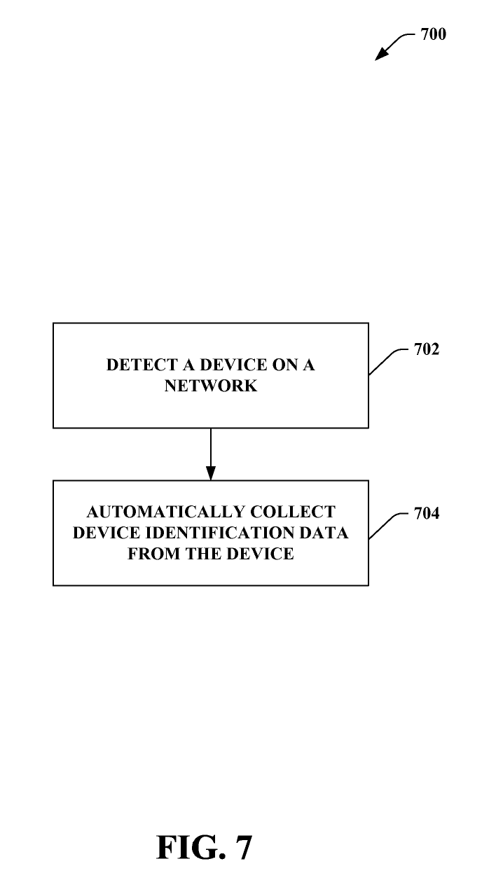

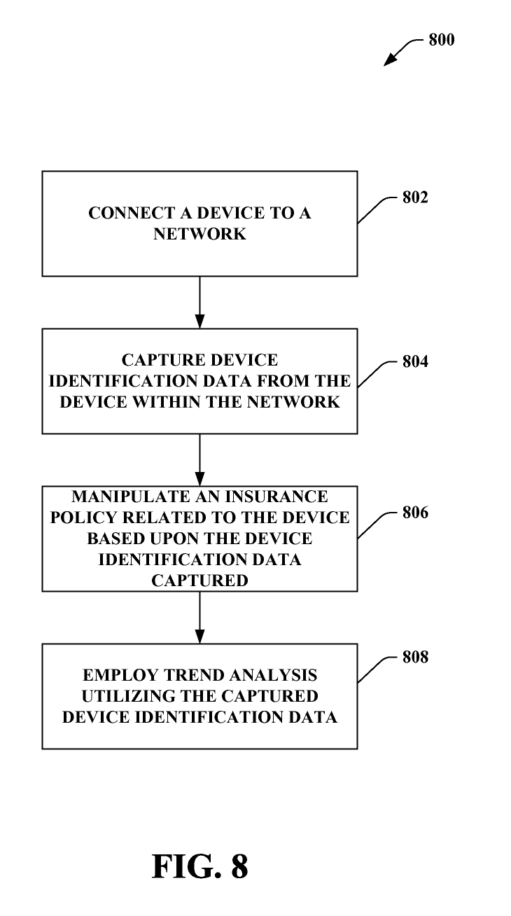

Referring to FIGS. 7-8, methodologies in accordance with various aspects of the claimed subject matter are illustrated. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

With reference to FIG. 7, illustrated is a methodology 700 for collecting and storing device identification data within a wireless communication network. At reference numeral 702, a device on a network can be detected. For instance, the device can be, but is not limited to being, user equipment, a mobile device, a communication device, a mobile communication device, a gaming device, a portable media player, a cellular phone, a mobile phone, a portable device (e.g., laptop, handheld such as a personal digital assistant (PDA), portable music player, portable gaming device, . . . ), a desktop device, a home media center, a smartphone, any suitable device that can include identification data, any suitable device that can be employed on the network 104, etc. For instance, a user can purchase a device such as a cellular phone, and purchase a service plan associated with a particular network, carrier, and/or service provider. The network can detect such cellular phone on the network upon, for instance, registering and/or activating such device.

At reference numeral 704, device identification data from the device can be automatically collected. For instance, the network can automatically capture device identification data upon the detection of such device on the network. It is to be appreciated that the device identification data (e.g., also referred to as the identification data) can be, but is not limited to being, International Mobile Station Equipment Identity (IMEI) data, device serial number, device identification number, consumer device linkage data (e.g., consumer address, consumer social security number, consumer name, etc.), and/or any other suitable data that can identify a device. Moreover, the identification data associated with the device can be utilized to track and/or glean information as to the devices on the network, the devices utilized by customers, users, consumers, and the like. The identification data can further be utilized for a plurality of services provided by the network such as, but not limited to, device insurance, trending analysis, marketing analysis, fraud prevention, etc.

FIG. 8 illustrates a methodology 800 that facilitates automatically registering a device with insurance via collected device identification data. At reference numeral 802, a device can be connected to a network. In particular, the device can be registered, activated, and/or connected to a wireless communications network. The device can be any suitable device that can connect to a network, wherein the device can be, but is not limited to, user equipment, a mobile device, a communication device, a mobile communication device, a gaming device, a portable media player, a cellular phone, a mobile phone, a portable device (e.g., laptop, handheld such as a personal digital assistant (PDA), portable music player, portable gaming device, . . . ), a desktop device, a home media center, a smartphone, any suitable device that can include identification data, any suitable device that can be employed on the network 104, etc.

At reference numeral 804, device identification data can be captured from the device within the network. In particular, the device identification data can be automatically captured upon the connection of such device onto the network. By collecting the device identification data, the network can ascertain the exact type of devices utilized by consumers and/or users. The device identification data (e.g., also referred to as identification data) can be, for instance, International Mobile Station Equipment Identity (IMEI) data, device serial number, device identification number, consumer device linkage data (e.g., consumer address, consumer social security number, consumer name, etc.), and/or any other suitable data that can identify a device.

At reference numeral 806, an insurance policy related to the device can be manipulated based upon the identification data captured. In particular, the insurance policy associated to the device and captured device identification data can be changed, updated, cancelled, enlisted, registered, and the like. For example, based on the erratic costs of devices, insurance rates and/or policies can be adjusted accordingly. Thus, a costly device may require a high monthly payment until the user changes devices. Upon changing the device, the network can collect identification data to ascertain the new device and subsequently lower the insurance monthly payment. In another example, the insurance rate can be a dynamically changing variable based at least in part upon data associated with the particular device insured such as, but not limited to, age of the device (e.g., insurance can lower as device gets older), frequency of repair required to that device, length of contract with network/carrier/service provider, payment history, frequency of insurance claim, customer/user loyalty to insurance provider, device parts prices, labor prices, device repair cost, and/or any other suitable factor associated with the device and/or the network.

At reference numeral 808, trend analysis can be employed utilizing the captured device identification data. For instance, the vast amount of device identification data can be aggregated in order to determine particular trends and/or tendencies associated with customers/users related to the network. In one example, tables, graphs, charts, reports, etc. can be created to be employed in areas such as marketing, business, sales, and the like. Collecting the device identification data allows the determination of the specific devices utilized by users/customers associated with the network. Such information can assist in determining what customers/consumers/users like and/or dislike in relation to devices. Moreover, such information can generally provide forecasting in terms of devices on the network.

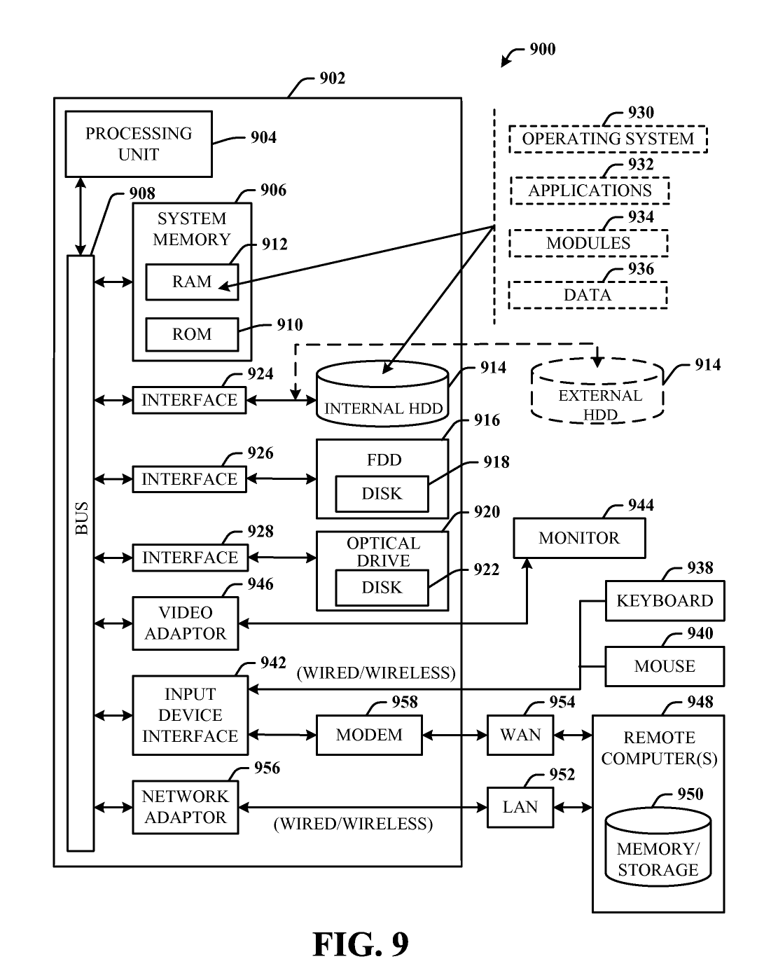

Referring now to FIG. 9, there is illustrated a block diagram of an example computing device such as a mobile device or a remote device described herein. In order to provide additional context for various aspects thereof, FIG. 9 and the following discussion are intended to provide a brief, general description of a suitable computing environment 900 in which the various aspects of the innovation can be implemented. While the description above is in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as a DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed innovation.

A number of program modules can be stored in the drives and RAM 912, including an operating system 930, one or more application programs 932, other program modules 934 and program data 936. All or portions of the operating system, applications, modules, and/or data can also be cached in the RAM 912. It is to be appreciated that the innovation can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adaptor 956 may facilitate wired or wireless communication to the LAN 952, which may also include a wireless access point disposed thereon for communicating with the wireless adaptor 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least WiFi and Bluetooth™ wireless technologies. Thus, the communication can be a predefined structure as with a conventional network or simply an ad hoc communication between at least two devices.

WiFi, or Wireless Fidelity, allows connection to the Internet from a couch at home, a bed in a hotel room, or a conference room at work, without wires. WiFi is a wireless technology similar to that used in a cell phone that enables such devices, e.g., computers, to send and receive data indoors and out; anywhere within the range of a base station. WiFi networks use radio technologies called IEEE 802.11 (a, b, g, etc.) to provide secure, reliable, fast wireless connectivity. A WiFi network can be used to connect computers to each other, to the Internet, and to wired networks (which use IEEE 802.3 or Ethernet). WiFi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

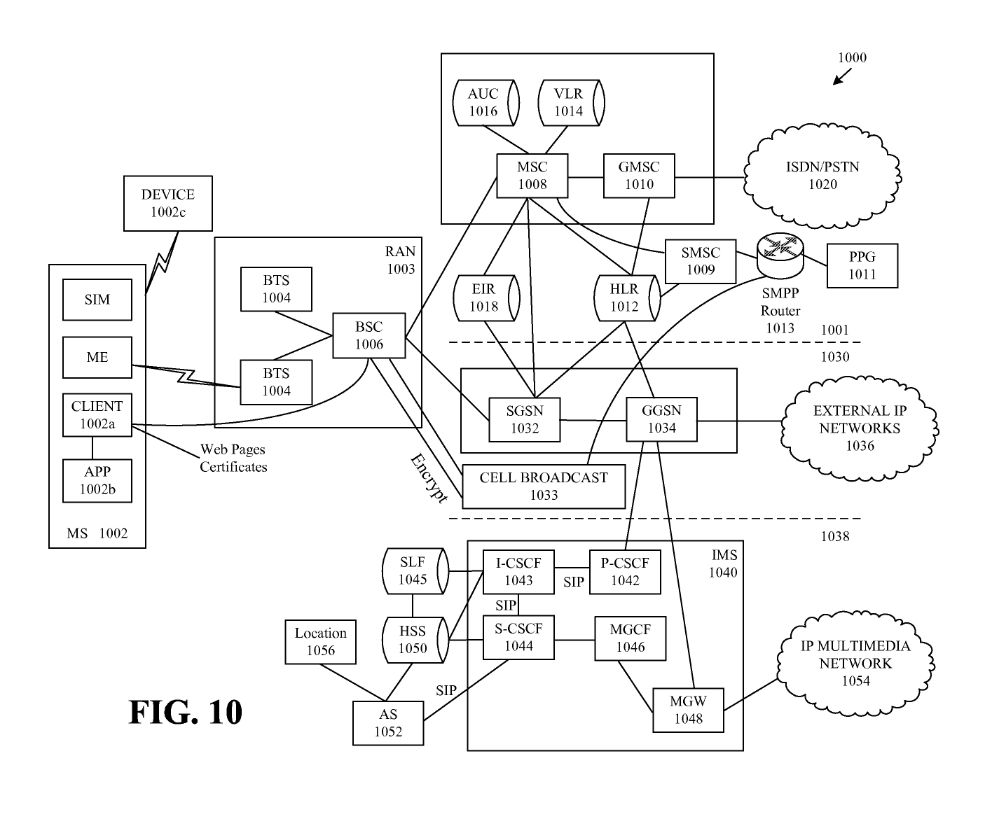

Now turning to FIG. 10, such figure depicts a GSM/GPRS/IP multimedia network architecture 1000 that includes a GSM core network 1001, a GPRS network 1030 and an IP multimedia network 1038. The GSM core network 1001 includes a Mobile Station (MS) 1002, at least one Base Transceiver Station (BTS) 1004 and a Base Station Controller (BSC) 1006. The MS 1002 is physical equipment or Mobile Equipment (ME), such as a mobile phone or a laptop computer that is used by mobile subscribers, with a Subscriber identity Module (SIM). The SIM includes an International Mobile Subscriber Identity (IMSI), which is a unique identifier of a subscriber. The MS 1002 includes an embedded client 1002a that receives and processes messages received by the MS 1002. The embedded client 1002a may be implemented in JAVA and is discuss more fully below.

The embedded client 1002a communicates with an application 1002b that provides services and/or information to an end user. One example of the application may be navigation software that provides near real-time traffic information that is received via the embedded client 1002a to the end user. The navigation software may provide road conditions, suggest alternate routes, etc. based on the location of the MS 1002. Those of ordinary skill in the art understand that there are many different methods and systems of locating an MS 1002.

Alternatively, the MS 1002 and a device 1002c may be enabled to communicate via a short-range wireless communication link, such as BLUETOOTH. For example, a BLUETOOTH SIM Access Profile may be provided in an automobile (e.g., device 1002c) that communicates with the SIM in the MS 1002 to enable the automobile's communications system to pull information from the MS 1002. The BLUETOOTH communication system in the vehicle becomes an “embedded phone” that employs an antenna associated with the automobile. The result is improved reception of calls made in the vehicle. As one of ordinary skill in the art would recognize, an automobile is one example of the device 1002c. There may be an endless number of devices 1002c that use the SIM within the MS 1002 to provide services, information, data, audio, video, etc. to end users.

The BTS 1004 is physical equipment, such as a radio tower, that enables a radio interface to communicate with the MS. Each BTS may serve more than one MS. The BSC 1006 manages radio resources, including the BTS. The BSC may be connected to several BTSs. The BSC and BTS components, in combination, are generally referred to as a base station (BSS) or radio access network (RAN) 1003.

The GSM core network 1001 also includes a Mobile Switching Center (MSC) 1008, a Gateway Mobile Switching Center (GMSC) 1010, a Home Location Register (HLR) 1012, Visitor Location Register (VLR) 1014, an Authentication Center (AuC) 1016, and an Equipment Identity Register (EIR) 1018. The MSC 1008 performs a switching function for the network. The MSC also performs other functions, such as registration, authentication, location updating, handovers, and call routing. The GMSC 1010 provides a gateway between the GSM network and other networks, such as an Integrated Services Digital Network (ISDN) or Public Switched Telephone Networks (PSTNs) 1020. In other words, the GMSC 1010 provides interworking functionality with external networks.

The HLR 1012 is a database or component(s) that comprises administrative information regarding each subscriber registered in a corresponding GSM network. The HLR 1012 also includes the current location of each MS. The VLR 1014 is a database or component(s) that contains selected administrative information from the HLR 1012. The VLR contains information necessary for call control and provision of subscribed services for each MS currently located in a geographical area controlled by the VLR. The HLR 1012 and the VLR 1014, together with the MSC 1008, provide the call routing and roaming capabilities of GSM. The AuC 1016 provides the parameters needed for authentication and encryption functions. Such parameters allow verification of a subscriber's identity. The EIR 1018 stores security-sensitive information about the mobile equipment.

A Short Message Service Center (SMSC) 1009 allows one-to-one Short Message Service (SMS) messages to be sent to/from the MS 1002. A Push Proxy Gateway (PPG) 1011 is used to “push” (e.g., send without a synchronous request) content to the MS 1002. The PPG 1011 acts as a proxy between wired and wireless networks to facilitate pushing of data to the MS 1002. A Short Message Peer to Peer (SMPP) protocol router 1013 is provided to convert SMS-based SMPP messages to cell broadcast messages. SMPP is a protocol for exchanging SMS messages between SMS peer entities such as short message service centers. It is often used to allow third parties, e.g., content suppliers such as news organizations, to submit bulk messages.

To gain access to GSM services, such as speech, data, and short message service (SMS), the MS first registers with the network to indicate its current location by performing a location update and IMSI attach procedure. The MS 1002 sends a location update including its current location information to the MSC/VLR, via the BTS 1004 and the BSC 1006. The location information is then sent to the MS's HLR. The HLR is updated with the location information received from the MSC/VLR. The location update also is performed when the MS moves to a new location area. Typically, the location update is periodically performed to update the database as location updating events occur.

The GPRS network 1030 is logically implemented on the GSM core network architecture by introducing two packet-switching network nodes, a serving GPRS support node (SGSN) 1032, a cell broadcast and a Gateway GPRS support node (GGSN) 1034. The SGSN 1032 is at the same hierarchical level as the MSC 1008 in the GSM network. The SGSN controls the connection between the GPRS network and the MS 1002. The SGSN also keeps track of individual MS's locations and security functions and access controls.

A Cell Broadcast Center (CBC) 1033 communicates cell broadcast messages that are typically delivered to multiple users in a specified area. Cell Broadcast is one-to-many geographically focused service. It enables messages to be communicated to multiple mobile phone customers who are located within a given part of its network coverage area at the time the message is broadcast.

The GGSN 1034 provides a gateway between the GPRS network and a public packet network (PDN) or other IP networks 1036. That is, the GGSN provides interworking functionality with external networks, and sets up a logical link to the MS through the SGSN. When packet-switched data leaves the GPRS network, it is transferred to an external TCP-IP network 1036, such as an X.25 network or the Internet. In order to access GPRS services, the MS first attaches itself to the GPRS network by performing an attach procedure. The MS then activates a packet data protocol (PDP) context, thus activating a packet communication session between the MS, the SGSN, and the GGSN.

In a GSM/GPRS network, GPRS services and GSM services can be used in parallel. The MS can operate in one three classes: class A, class B, and class C. A class A MS can attach to the network for both GPRS services and GSM services simultaneously. A class A MS also supports simultaneous operation of GPRS services and GSM services. For example, class A mobiles can receive GSM voice/data/SMS calls and GPRS data calls at the same time. A class B MS can attach to the network for both GPRS services and GSM services simultaneously. However, a class B MS does not support simultaneous operation of the GPRS services and GSM services. That is, a class B MS can only use one of the two services at a given time. A class C MS can attach for only one of the GPRS services and GSM services at a time. Simultaneous attachment and operation of GPRS services and GSM services is not possible with a class C MS.

A GPRS network 1030 can be designed to operate in three network operation modes (NOM1, NOM2 and NOM3). A network operation mode of a GPRS network is indicated by a parameter in system information messages transmitted within a cell. The system information messages dictates a MS where to listen for paging messages and how to signal towards the network. The network operation mode represents the capabilities of the GPRS network. In a NOM1 network, a MS can receive pages from a circuit switched domain (voice call) when engaged in a data call. The MS can suspend the data call or take both simultaneously, depending on the ability of the MS. In a NOM2 network, a MS may not receive pages from a circuit switched domain when engaged in a data call, since the MS is receiving data and is not listening to a paging channel. In a NOM3 network, a MS can monitor pages for a circuit switched network while received data and vice versa.

The IP multimedia network 1038 was introduced with 3GPP Release 5, and includes an IP multimedia subsystem (IMS) 1040 to provide rich multimedia services to end users. A representative set of the network entities within the IMS 1040 are a call/session control function (CSCF), a media gateway control function (MGCF) 1046, a media gateway (MGW) 1048, and a master subscriber database, called a home subscriber server (HSS) 1050. The HSS 1050 may be common to the GSM network 1001, the GPRS network 1030 as well as the IP multimedia network 1038.

The IP multimedia system 1040 is built around the call/session control function, of which there are three types: an interrogating CSCF (I-CSCF) 1043, a proxy CSCF (P-CSCF) 1042, and a serving CSCF (S-CSCF) 1044. The P-CSCF 1042 is the MS's first point of contact with the IMS 1040. The P-CSCF 1042 forwards session initiation protocol (SIP) messages received from the MS to an SIP server in a home network (and vice versa) of the MS. The P-CSCF 1042 may also modify an outgoing request according to a set of rules defined by the network operator (for example, address analysis and potential modification).

The I-CSCF 1043 forms an entrance to a home network and hides the inner topology of the home network from other networks and provides flexibility for selecting an S-CSCF. The I-CSCF 1043 may contact a subscriber location function (SLF) 1045 to determine which HSS 1050 to use for the particular subscriber, if multiple HSSs 1050 are present. The S-CSCF 1044 performs the session control services for the MS 1002. This includes routing originating sessions to external networks and routing terminating sessions to visited networks. The S-CSCF 1044 also decides whether an application server (AS) 1052 is required to receive information on an incoming SIP session request to ensure appropriate service handling. This decision is based on information received from the HSS 1050 (or other sources, such as an application server 1052). The AS 1052 also communicates to a location server 1056 (e.g., a Gateway Mobile Location Center (GMLC)) that provides a position (e.g., latitude/longitude coordinates) of the MS 1002.

The HSS 1050 contains a subscriber profile and keeps track of which core network node is currently handling the subscriber. It also supports subscriber authentication and authorization functions (AAA). In networks with more than one HSS 1050, a subscriber location function provides information on the HSS 1050 that contains the profile of a given subscriber.

The MGCF 1046 provides interworking functionality between SIP session control signaling from the IMS 1040 and ISUP/BICC call control signaling from the external GSTN networks (not shown). It also controls the media gateway (MGW) 1048 that provides user-plane interworking functionality (e.g., converting between AMR- and PCM-coded voice). The MGW 1048 also communicates with other IP multimedia networks 1054.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of such matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates collecting data within a wireless communications network, comprising:
a device connected to the wireless communications network; and
a retrieval component incorporated into the wireless communications network that automatically collects identification data associated with the device, the identification data specifies the type of device connected to the wireless communications network.

2. The system of claim 1, the device is at least one of user equipment, a mobile device, a communication device, a mobile communication device, a gaming device, a portable media player, a cellular phone, a mobile phone, a portable device, a laptop, a handheld, a personal digital assistant (PDA), a portable music player, a portable gaming device, a desktop device, a home media center, a smartphone, a device that connects to the wireless communications network, and a device that includes identification data.

3. The system of claim 1, the identification data is at least one of International Mobile Station Equipment Identity (IMEI) data, a device serial number, a device identification number, consumer device linkage data, a consumer address, a consumer social security number, a consumer name, and data that identifies a device on the wireless communications network.

4. The system of claim 1, the retrieval component periodically captures the identification data from the device based at least in part upon a time interval.

5. The system of claim 1, the retrieval component compares the identification data with a data store that includes previously collected identification for the device.

6. The system of claim 1, further comprising an insurance component that employs insurance coverage for the device based at least in part upon the collected identification data relating to the device.

7. The system of claim 6, the insurance component calculates an insurance rate associated with the device identified by the identification data based upon a characteristic of the device.

8. The system of claim 7, the characteristic is at least one of a brand of the device, a model of the device, a functional capability of the device, a device detail, an age of the device, a frequency of repair required to the device, a length of contract with the wireless communications network, a payment history, a frequency of insurance claim, a length of user loyalty to insurance provider, a device part price, a price associated with labor for repair, a device repair cost, a factor related to the network that forecasts the increate of insurance, a factor related to the network that forecasts the decrease of insurance, a factor related to the device that forecasts the increate of insurance, and a factor related to the device that forecasts the decrease of insurance.

9. The system of claim 6, the insurance component ensures the insurance coverage corresponds to the device specified by the identification data.

10. The system of claim 1, further comprising a dynamic insurance component that employs a dynamic insurance rate respective to the device based at least in part upon the identification data.

11. The system of claim 10, the dynamic insurance component employs the dynamic insurance rate based upon a detail associated with the device specified by the identification data.

12. The system of claim 11, the detail is at least one of a brand of the device, a model of the device, a functional capability of the device, a device detail, an age of the device, a frequency of repair required to the device, a length of contract with the wireless communications network, a payment history, a frequency of insurance claim, a length of user loyalty to insurance provider, a device part price, a price associated with labor for repair, a device repair cost, a factor related to the network that forecasts the increate of insurance, a factor related to the network that forecasts the decrease of insurance, a factor related to the device that forecasts the increate of insurance, and a factor related to the device that forecasts the decrease of insurance.

13. The system of claim 1, further comprising a trend component that utilizes the captured identification data to provide at least one of trending analysis and data analysis.

14. The system of claim 13, the trend component gleans aggregated data related to the collected identification data to ascertain a tendency associated with at least one of the wireless communications network, marketing connected to the wireless communications network, business related to the wireless communications network, and sales respective to the wireless communications network.

15. The system of claim 14, the trend component creates data relating to forecasting information, the data is at least one of a table, a graph, a chart, a report, a document, and an electronic file.

16. A method that facilitates aggregating data associated with a device on a network, comprising:
detecting a device on a network; and
automatically collecting device identification data from the device that specifies the particular device detected on the network.

17. The method of claim 16, the device identification data is at least one of International Mobile Station Equipment Identity (IMEI) data, a device serial number, a device identification number, consumer device linkage data, a consumer address, a consumer social security number, a consumer name, and data that identifies a device on the wireless communications network.

18. The method of claim 16, the device is at least one of user equipment, a mobile device, a communication device, a mobile communication device, a gaming device, a portable media player, a cellular phone, a mobile phone, a portable device, a laptop, a handheld, a personal digital assistant (PDA), a portable music player, a portable gaming device, a desktop device, a home media center, a smartphone, a device that connects to the wireless communications network, and a device that includes identification data.

19. The method of claim 16, further comprising:
manipulating an insurance policy related to the device based upon the device identification data collected, and
employing trend analysis based at least in part upon the collected device identification data.

20. A system that facilitates capturing data within a wireless communications network, comprising:
means for detecting a device connected to a wireless communications network; and
means for automatically collecting identification data associated with the device, the identification data specifies the type of device connected to the wireless communications network.
